(19) United States
(12) Patent Application Publication
(10) Pub. No.: US 2023/0208266 A1
(43) Pub. Date: Jun. 29, 2023

(54) Haptic Actuator Containing a High Modulus Polymer Composition with High Heat Resistance

(71) Applicant: Ticona LLC, Florence, KY (US)

(72) Inventor: Young Shin Kim, Cincinnati, OH (US)

(21) Appl. No.: 18/085,617

(22) Filed: Dec. 21, 2022

Related U.S. Application Data
(60) Provisional application No. 63/402,997, filed on Sep. 1, 2022.
(60) Provisional application No. 63/293,235, filed on Dec. 23, 2021.

(51) Int. Cl. H02K 33/18; C09K 19/12; C09K 19/32; C09K 19/42; C09K 19/52

(52) U.S. Cl. CPC H02K 33/18; C09K 19/12; C09K 19/322; C09K 19/42; C09K 19/52; C09K 2019/122; C09K 2019/323; C09K 2019/521; G06F 3/016

(57) ABSTRACT

A haptic actuator is provided. The haptic actuator comprises a housing having a top and a bottom and at least one sidewall between the top and bottom first and second permanent magnets carried by the top and bottom, respectively, of the housing, a field member carried by the housing and comprising at least one coil between the first and second permanent magnets, first and second ends; and optionally, one or more mechanical stiffeners carried by the top of the housing, the bottom of the housing, or both. The haptic actuator comprises a polymer composition that has a melting temperature of about 250° C. or more and a tensile modulus of about 16,000 MPa or more as determined in accordance with ISO 527:2019 at a temperature of 23° C.

### RELATED APPLICATIONS

The present application is based upon and claims priority to U.S. Provisional Patent Application Ser. No. 63/293,235, having a filing date of Dec. 23, 2021, and U.S. Provisional Patent Application Ser. No. 63/402,997, having a filing date of Sep. 1, 2022, which are incorporated herein by reference.

### BACKGROUND OF THE INVENTION

Haptic technology is becoming a more popular way of conveying information to a user. Haptic technology, which may simply be referred to as haptics, is a tactile feedback-based technology that stimulates a user's sense of touch by imparting relative amounts of force to the user.

A haptic device or haptic actuator is an example of a device that provides the tactile feedback to the user. In particular, the haptic device or actuator may apply relative amounts of force to a user through actuation of a mass that is part of the haptic device. Through various forms of tactile feedback, for example, generated relatively long and short bursts of force or vibrations, information may be conveyed to the user.

It is generally desired for polymeric components used in haptic actuators to have high creep resistance and stiffness. Additionally, as the assembly of electronic devices containing haptic actuators can include exposure of the haptic actuators to high temperatures, it is desirable that the polymeric components also have high heat resistance.

As such, a need exists for a haptic actuator containing a material high in stiffness and heat resistance.

### SUMMARY OF THE INVENTION

In accordance with one embodiment of the present invention, a haptic actuator is provided. The haptic actuator comprises a housing having a top and a bottom and at least one sidewall between the top and bottom, first and second permanent magnets carried by the top and bottom, respectively, of the housing, a field member carried by the housing and comprising at least one coil between the first and second permanent magnets, first and second ends, and optionally, one or more mechanical stiffeners carried by the top of the housing, the bottom of the housing, or both. The haptic actuator comprises a polymer composition that has a melting temperature of about 250° C. or more and a tensile modulus of about 16,000 MPa or more as determined in accordance with ISO 527:2019 at a temperature of 23° C.

Other features and aspects of the present invention are set forth in greater detail below.

### BRIEF DESCRIPTION OF THE FIGURES

A full and enabling disclosure of the present invention, including the best mode thereof to one skilled in the art, is set forth more particularly in the remainder of the specification, including reference to the accompanying figures, in which:

FIG. 1 is a perspective view of a portion of a haptic actuator according to an embodiment of the present invention; and

FIG. 2 is an exploded perspective view of the haptic actuator of FIG. 1.

### DETAILED DESCRIPTION

It is to be understood by one of ordinary skill in the art that the present discussion is a description of exemplary embodiments only, and is not intended as limiting the broader aspects of the present invention.

Generally speaking, the present invention is directed to a haptic actuator comprising a polymer composition comprising a polymer matrix and a plurality of reinforcing fibers that has a unique combination of stiffness and high heat resistance that enables it to function well in a haptic actuator. For example, the tensile modulus of the composition is generally about 16,000 MPa or more, in some embodiments about 20,000 MPa or more, in some embodiments from about 20,500 MPa to about 40,000 MPa, in some embodiments from about 21,000 MPa to about 36,000 MPa, in some embodiments from about 22,000 MPa to about 25,000 MPa, and in some embodiments, from about 30,000 MPa to about 36,000 MPa, as determined in accordance with ISO 527:2019 at 23° C. Additionally, the melting temperature of the composition is generally about 250° C. or more, in some embodiments about 280° C. or more, in some embodiments about 290° C. or more, in some embodiments about 300° C. or more, and in some embodiments, from about 310° C. to about 360° C.

The composition may also exhibit a tensile strength of from about 120 to about 500 MPa, in some embodiments from about 130 to about 400 MPa, and in some embodiments, from about 140 to about 350 MPa and/or a tensile break strain of about 0.3% or more, in some embodiments from about 0.5% to about 5%, and in some embodiments, from about 0.8% to about 3%, as determined in accordance with ISO 527:2019 at 23° C. The polymer composition may also exhibit a flexural modulus of about 15,000 MPa or more, in some embodiments from about 19,000 MPa to about 40,000 MPa, in some embodiments from about 20,000 MPa to about 25,000 MPa, and in some embodiments, from about 30,000 MPa to about 35,000 MPa; a flexural strength of from about 100 to about 500 MPa, in some embodiments from about 150 to about 400 MPa, and in some embodiments, from about 200 to about 350 MPa; and/or a flexural break strain of about 0.3% or more, in some embodiments from about 0.8% to about 5%, and in some embodiments, from about 1.4% to about 3%, as determined in accordance with ISO 178:2019 at 23° C. The composition may also exhibit a Charpy notched impact strength of about 5 kJ/m² or more, in some embodiments from about 10 to about 30 kJ/m², and in some embodiments, from about 15 to about 25 kJ/m², and/or a Charpy unnotched impact strength of about 10 kJ/m² or more, in some embodiments from about 15 kJ/m² to about 50 kJ/m², in some embodiments from about 20 to about 45 kJ/m², and in some embodiments, from about 25 to about 35 kJ/m² measured at 23° C. according to ISO 179-1:2010. Further, the deflection temperature under load (DTUL) may be about 180° C. or more, in some embodiments from about 200° C. to about 350° C., in some embodiments from about 225° C. to about 325° C., and in some embodiments, from about 240° C. to about 300° C., as measured according to ASTM D648-18 (technically equivalent to ISO 75-2:2013) at a specified load of 1.8 MPa.

Further, the polymer composition may have a melt viscosity of about 300 Pa-s or less, in some embodiments about 200 Pa-s or less, in some embodiments about 100 Pa-s or less, in some embodiments from about 10 to about 90 Pa-s, in some embodiments from about 10 to about 80 Pa-s, and in some embodiments, from about 30 to about 60 Pa-s, determined at a shear rate of 400 seconds⁻¹ and/or a melt viscosity of about 200 Pa-s or less, in some embodiments about 100 Pa-s or less, in some embodiments from about 10 to about 70 Pa-s, in some embodiments from about 10 to about 60 Pa-s, and in some embodiments, from about 30 to about 45 Pa-s, determined at a shear rate of 1000 seconds⁻¹. Melt viscosity may be determined in accordance with ISO 11443:2021 at a temperature that is 15° C. higher than the melting temperature of the composition.

Various embodiments of the present invention will now be described in more detail.

### I. Polymer Composition

A. Polymer Matrix

The polymer matrix typically contains one or more liquid crystalline polymers, generally in an amount of from about 30 wt. % to about 90 wt. %, in some embodiments from about 45 wt. % to about 75 wt. %, in some embodiments from about 50 wt. % to about 70 wt. %, and in some embodiments, from about 55 wt. % to about 65 wt. % of the entire polymer composition. Liquid crystalline polymers are generally classified as “thermotropic” to the extent that they can possess a rod-like structure and exhibit a crystalline behavior in their molten state (e.g., thermotropic nematic state). The liquid crystalline polymers employed in the polymer composition can have a melting temperature of about 200° C. or more, in some embodiments from about 220° C. to about 350° C., and in some embodiments, from about 260° C. to about 330° C., provided that the melting point of the composition as a whole is about 280° C. or more. The melting temperature may be determined as is well known in the art using differential scanning calorimetry (“DSC”), such as determined by ISO Test No. 11357-3:2011. Such polymers may be formed from one or more types of repeating units as is known in the art. A liquid crystalline polymer may, for example, contain one or more aromatic ester repeating units generally represented by the following Formula (I):

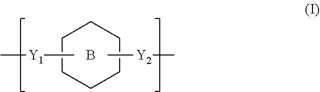

wherein,

ring B is a substituted or unsubstituted 6-membered aryl group (e.g., 1,4-phenylene or 1,3-phenylene), a substituted or unsubstituted 6-membered aryl group fused to a substituted or unsubstituted 5- or 6-membered aryl group (e.g., 2,6-naphthalene), or a substituted or unsubstituted 6-membered aryl group linked to a substituted or unsubstituted 5- or 6-membered aryl group (e.g., 4,4-biphenylene); and

Y₁ and Y₂ are independently O, C(O), NH, C(O)HN, or NHC(O).

Typically, at least one of Y₁ and Y₂ are C(O). Examples of such aromatic ester repeating units may include, for instance, aromatic dicarboxylic repeating units (Y₁ and Y₂ in Formula I are C(O)), aromatic hydroxycarboxylic repeating units (Y₁ is O and Y₂ is C(O) in Formula I), as well as various combinations thereof.

Aromatic hydroxycarboxylic repeating units, for instance, may be employed that are derived from aromatic hydroxycarboxylic acids, such as, 4-hydroxybenzoic acid; 4-hydroxy-4′-biphenylcarboxylic acid; 2-hydroxy-6-naphthoic acid; 2-hydroxy-5-naphthoic acid; 3-hydroxy-2-naphthoic acid; 2-hydroxy-3-naphthoic acid; 4′-hydroxyphenyl-4-benzoic acid; 3′-hydroxyphenyl-4-benzoic acid; 4′-hydroxyphenyl-3-benzoic acid, etc., as well as alkyl, alkoxy, aryl and halogen substituents thereof, and combination thereof. Particularly suitable aromatic hydroxycarboxylic acids are 4-hydroxybenzoic acid (“HBA”) and 6-hydroxy-2-naphthoic acid (“HNA”). When employed, repeating units derived from hydroxycarboxylic acids (e.g., HBA and/or HNA) typically constitute about 30 mol. % or more, in some embodiments from about 40 mol. % to about 80 mol. %, and in some embodiments, from about 50 mol. % to 70 mol. % of the polymer.

Aromatic dicarboxylic repeating units may also be employed that are derived from aromatic dicarboxylic acids, such as terephthalic acid, isophthalic acid, 2,6-naphthalenedicarboxylic acid, diphenyl ether-4,4′-dicarboxylic acid, 1,6-naphthalenedicarboxylic acid, 2,7-naphthalenedicarboxylic acid, 4,4′-dicarboxybiphenyl, bis(4-carboxyphenyl)ether, bis(4-carboxyphenyl)butane, bis(4-carboxyphenyl)ethane, bis(3-carboxyphenyl)ether, bis(3-carboxyphenyl)ethane, etc., as well as alkyl, alkoxy, aryl and halogen substituents thereof, and combinations thereof. Particularly suitable aromatic dicarboxylic acids may include, for instance, terephthalic acid (“TA”), isophthalic acid (“IA”), and 2,6-naphthalenedicarboxylic acid (“NDA”). When employed, repeating units derived from aromatic dicarboxylic acids (e.g., IA, TA, and/or NDA) each typically constitute from about 1 mol. % to about 50 mol. %, in some embodiments from about 2 mol. % to about 40 mol. %, and in some embodiments, from about 5 mol. % to about 30 mol. % of the polymer.

Other repeating units may also be employed in the polymer. In certain embodiments, for instance, repeating units may be employed that are derived from aromatic diols, such as hydroquinone, resorcinol, 2,6-dihydroxynaphthalene, 2,7-dihydroxynaphthalene, 1,6-dihydroxynaphthalene, 4,4′-dihydroxybiphenyl (or 4,4′-biphenol), 3,3′-dihydroxybiphenyl, 3,4′-dihydroxybiphenyl, 4,4′-dihydroxybiphenyl ether, bis(4-hydroxyphenyl)ethane, etc., as well as alkyl, alkoxy, aryl and halogen substituents thereof, and combinations thereof. Particularly suitable aromatic diols may include, for instance, hydroquinone (“HQ”) and 4,4′-biphenol (“BP”). When employed, repeating units derived from aromatic diols (e.g., HQ and/or BP) each typically constitute from about 1 mol. % to about 30 mol. %, in some embodiments from about 2 mol. % to about 25 mol. %, and in some embodiments, from about 5 mol. % to about 20 mol. % of the polymer. Repeating units may also be employed, such as those derived from aromatic amides (e.g., acetaminophen (“APAP”)) and/or aromatic amines (e.g., 4-aminophenol (“AP”), 3-aminophenol, 1,4-phenylenediamine, 1,3-phenylenediamine, etc.). When employed, repeating units derived from aromatic amides (e.g., APAP) and/or aromatic amines (e.g., AP) typically constitute from about 0.1 mol. % to about 20 mol. %, in some embodiments from about 0.5 mol. % to about 15 mol. %, and in some embodiments, from about 1 mol. % to about 10 mol. % of the polymer. It should also be understood that various other monomeric repeating units may be incorporated into the polymer. For instance, in certain embodiments, the polymer may contain one or more repeating units derived from non-aromatic monomers, such as aliphatic or cycloaliphatic hydroxycarboxylic acids, dicarboxylic acids, diols, amides, amines, etc. Of course, in other embodiments, the polymer may be “wholly aromatic” in that it lacks repeating units derived from non-aromatic (e.g., aliphatic or cycloaliphatic) monomers.

In some embodiments, the composition contains a “low naphthenic” liquid crystalline polymer containing a low content of repeating units derived from naphthenic hydroxycarboxylic acids and naphthenic dicarboxylic acids, such as naphthalene-2,6-dicarboxylic acid (“NDA”), 6-hydroxy-2-naphthoic acid (“HNA”), or combinations thereof. That is, the total amount of repeating units derived from naphthenic hydroxycarboxylic and/or dicarboxylic acids (e.g., NDA, HNA, or a combination of HNA and NDA) can be about 15 mol. % or less, in some embodiments about 10 mol. % or less, in some embodiments about 6 mol. % or less, and in some embodiments, from 0 mol. % to about 5 mol. % of the polymer. In one embodiment, for instance, the repeating units derived from HNA and/or NDA may be 0 mol. % of the polymer. In such embodiments, the polymer may contain repeating units derived from HBA in an amount of from about 40 mol. % to about 80 mol. %, and in some embodiments from about 45 mol. % to about 75 mol. %, and in some embodiments, from about 50 mol. % to about 70 mol. %. The polymer may also contain aromatic dicarboxylic acid(s) (e.g., IA and/or TA) in an amount of from about 1 mol. % to about 20 mol. %, and in some embodiments, from about 4 mol. % to about 15 mol. %, and/or aromatic diol(s) (e.g., BP and/or HQ) in an amount of from about 1 mol. % to about 20 mol. %, and in some embodiments, from about 4 mol. % to about 15 mol. %. In certain instances, the molar ratio of BP to HQ may be selectively controlled so that it is from about 0.8 to about 2.5, in some embodiments from about 1 to about 2.2, and in some embodiments, from about 1.1 to about 2 and/or the molar ratio of TA to IA may be selectively controlled so that it is from about 0.8 to about 2.5, in some embodiments from about 1 to about 2.2, and in some embodiments, from about 1.1 to about 2. For example, BP may be used in a molar amount greater than HQ such that the molar ratio is greater than 1 and/or TA may be used in a molar amount greater than IA such that the molar ratio is greater than 1.

In some embodiments, the polymer composition contains a “high naphthenic” liquid crystalline polymer containing a relatively high content of repeating units derived from naphthenic hydroxycarboxylic acids and naphthenic dicarboxylic acids, such as naphthalene-2,6-dicarboxylic acid (“NDA”), 6-hydroxy-2-naphthoic acid (“HNA”), or combinations thereof. That is, the total amount of repeating units derived from naphthenic hydroxycarboxylic and/or dicarboxylic acids (e.g., NDA, HNA, or a combination of HNA and NDA) can be greater than about 15 mol. %, in some embodiments about 18 mol. % or more, and in some embodiments, from about 20 mol. % to about 60 mol. % of the polymer. In one particular embodiment, for instance, the repeating units derived from 6-hydroxy-2-naphthoic acid (“HNA”) may constitute from about 10 mol. % to about 40 mol. %, in some embodiments from about 15 mol. % to about 35 mol. %, and in some embodiments, from about 20 mol. % to about 30 mol. % of the polymer. In such embodiments, the liquid crystalline polymer may also contain various other monomers, such as aromatic hydroxycarboxylic acid(s) (e.g., HBA) in an amount of from about 10 mol. % to about 85 mol. %, in some embodiments from about 40 mol % to about 82 mol % and in some embodiments, from about 70 mol. % to about 80 mol. %; aromatic dicarboxylic acid(s) (e.g., IA and/or TA) in an amount of from about 0 mol. % to about 30 mol. %, and in some embodiments, from about 2 mol. % to about 25 mol. %; and/or aromatic diol(s) (e.g., BP and/or HQ) in an amount of from about 0 mol. % to about 40 mol. %, and in some embodiments, from about 2 mol. % to about 35 mol. %. In some embodiments, the high naphthenic liquid crystalline polymer contains a small amount of aromatic dicarboxylic acid in addition to a naphthenic hydroxycarboxylic acid and HBA. For instance, the liquid crystalline polymer can contain TA and/or IA in an amount from about 0.1 mol. % to about 5 mol. %, in some embodiments from about 0.2 mol. % to about 2 mol. %, and in some embodiments, from about 0.5 mol. % to about 1 mol. %.

In certain embodiments, all of the liquid crystalline polymers are “low naphthenic” polymers such as described above. In other embodiments, all of the liquid crystalline polymers are “high naphthenic” polymers such as described above. In some cases, blends of such polymers may also be used. For example, low naphthenic liquid crystalline polymers may constitute from about 50 wt. % to about 95 wt. %, in some embodiments from about 60 wt. % to about 90 wt. %, and in some embodiments, from about 75 wt. % to about 85 wt. % of the total amount of liquid crystalline polymers in the composition, and high naphthenic liquid crystalline polymers may constitute from about 5 wt. % to about 50 wt. %, in some embodiments from about 10 wt. % to about 40 wt. %, and in some embodiments, from about 15 wt. % to about 25 wt. % of the total amount of liquid crystalline polymers in the composition. In other embodiments, high naphthenic liquid crystalline polymers may constitute from about 50 wt. % to about 99 wt. %, in some embodiments from about 80 wt. % to about 97 wt. %, and in some embodiments, from about 90 wt. % to about 95 wt. % of the total amount of liquid crystalline polymers in the composition, and low naphthenic liquid crystalline polymers may constitute from about 1 wt. % to about 50 wt. %, in some embodiments from about 3 wt. % to about 20 wt. %, and in some embodiments, from about 5 wt. % to about 10 wt. % of the total amount of liquid crystalline polymers in the composition.

B. Reinforcing Fibers

In order to provide the polymer composition with such a high modulus, reinforcing fibers are typically dispersed within the polymer matrix. Any of a variety of different types of reinforcing fibers may generally be employed in the polymer composition of the present invention, such as polymer fibers, metal fibers, carbonaceous fibers (e.g., graphite, carbide, etc.), inorganic fibers, etc., as well as combinations thereof. In some embodiments, the composition contains inorganic fibers, such as those that are derived from glass; titanates (e.g., potassium titanate); silicates, such as neosilicates, sorosilicates, inosilicates (e.g., calcium inosilicates, such as wollastonite; calcium magnesium inosilicates, such as tremolite; calcium magnesium iron inosilicates, such as actinolite; magnesium iron inosilicates, such as anthophyllite; etc.), phyllosilicates (e.g., aluminum phyllosilicates, such as palygorskite), tectosilicates, etc.; sulfates, such as calcium sulfates (e.g., dehydrated or anhydrous gypsum); mineral wools (e.g., rock or slag wool); and so forth. Glass fibers may be particularly suitable for use in the present invention, such as those formed from E-glass, A-glass, C-glass, D-glass, AR-glass, R-glass, S1-glass, S2-glass, etc., as well as mixtures thereof. Carbon fibers, such as polyacrylonitrile (PAN) based or pitch based carbon fibers, are also particularly suitable for use in the polymer composition, as they generally have high stiffness. If desired, the reinforcing fibers may be provided with a sizing agent or other coating as is known in the art.

The amount of reinforcing fibers may be selectively controlled to achieve the desired combination of stiffness and heat resistance. The reinforcing fibers may, for example, be employed in an amount of from about 10% to about 70%, in some embodiments from about 20% to about 60%, in some embodiments from about 30% to about 55%, in some embodiments from about 35 wt. % to about 50 wt. %, and in some embodiments, from about 35% to about 45%, by weight of the polymer composition. In some embodiments, the reinforcing fibers comprise only glass fibers. In other embodiments, the composition contains both glass fibers and carbon fibers. In such embodiments, the ratio of glass fibers to carbon fibers can be from about 1:10 to about 25:1, in some embodiments from about 1:1 to about 20:1, in some embodiments from in some embodiments from about 2:1 to about 15:1, in some embodiments from about 5:1 to about 15:1, and in some embodiments, from about 6:1 to about 13:1. For instance, in one embodiment, glass fibers may comprise from about 10 wt. % to about 50 wt. %, in some embodiments from about 15 wt. % to about 45 wt. %, and in some embodiments, from about 25 wt. % to about 40 wt. % of the composition, while carbon fibers may comprise from about 0.5 wt. % to about 10 wt. %, in some embodiments from about 1 wt. % to about 8 wt. %, and in some embodiments, from about 1.5 wt. % to about 7 wt. % of the composition.

In some embodiments, the reinforcing fibers may contain only carbon fibers. In such embodiments, the carbon fibers may constitute from about 10 wt. % to about 50 wt. %, such as from about 25 wt. % to about 40 wt. % of the composition. The present inventor discovered that haptic actuators produced from compositions using carbon fibers as the reinforcing fibers can be quieter than those formed from compositions using glass fibers as the reinforcing fibers.

C. Optional Components

A wide variety of additional additives can also be included in the polymer composition, such as particulate fillers (e.g., talc, mica, etc.), antimicrobials, pigments (e.g., carbon black), antioxidants, stabilizers, surfactants, waxes, solid solvents, flame retardants, anti-drip additives, and other materials added to enhance properties and processability. Lubricants may also be employed in the polymer composition that are capable of withstanding the processing conditions of the liquid crystalline polymer without substantial decomposition. Examples of such lubricants include fatty acids esters, the salts thereof, esters, fatty acid amides, organic phosphate esters, and hydrocarbon waxes of the type commonly used as lubricants in the processing of engineering plastic materials, including mixtures thereof. Suitable fatty acids typically have a backbone carbon chain of from about 12 to about 60 carbon atoms, such as myristic acid, palmitic acid, stearic acid, arachic acid, montanic acid, octadecinic acid, parinric acid, and so forth. Suitable esters include fatty acid esters, fatty alcohol esters, wax esters, glycerol esters, glycol esters and complex esters. Fatty acid amides include fatty primary amides, fatty secondary amides, methylene and ethylene bisamides and alkanolamides such as, for example, palmitic acid amide, stearic acid amide, oleic acid amide, N,N′-ethylenebisstearamide and so forth. Also suitable are the metal salts of fatty acids such as calcium stearate, zinc stearate, magnesium stearate, and so forth; hydrocarbon waxes, including paraffin waxes, polyolefin and oxidized polyolefin waxes, and microcrystalline waxes. Particularly suitable lubricants are acids, salts, or amides of stearic acid, such as pentaerythritol tetrastearate, calcium stearate, or N,N′-ethylenebisstearamide. When employed, the lubricant(s) typically constitute from about 0.05 wt. % to about 1.5 wt. %, and in some embodiments, from about 0.1 wt. % to about 0.5 wt. % (by weight) of the polymer composition.

The components used to form the polymer composition may be combined together using any of a variety of different techniques as is known in the art. In one particular embodiment, for example, the liquid crystalline polymer, reinforcing fibers, and other optional additives are melt processed as a mixture within an extruder to form the polymer composition. The mixture may be melt-kneaded in a single-screw or multi-screw extruder, such as at a temperature of from about 250° C. to about 450° C. In one embodiment, the mixture may be melt processed in an extruder that includes multiple temperature zones. The temperature of individual zones is typically set within about −60° C. to about 25° C. relative to the melting temperature of the polymer. By way of example, the mixture may be melt processed using a twin screw extruder such as a Leistritz 18-mm co-rotating fully intermeshing twin screw extruder. A general purpose screw design can be used to melt process the mixture. In one embodiment, the mixture including all of the components may be fed to the feed throat in the first barrel by means of a volumetric feeder. In another embodiment, different components may be added at different addition points in the extruder, as is known. For example, the polymer may be applied at the feed throat, and certain additives (e.g., reinforcing fibers) may be supplied at the same or different temperature zone located downstream therefrom. Regardless, the resulting mixture can be melted and mixed then extruded through a die. The extruded polymer composition can then be quenched in a water bath to solidify and granulated in a pelletizer followed by drying.

### II. Haptic Actuator

As indicated above, the polymer composition of the present invention may be employed in a haptic actuator. Typically, the haptic actuator comprises a housing having a top and a bottom and at least one sidewall between the top and bottom, first and second permanent magnets carried by the top and bottom, respectively, of the housing, a field member carried by the housing and comprising at least one coil between the first and second permanent magnets, first and second ends, and optionally, one or more mechanical stiffeners carried by the top of the housing, the bottom of the housing, or both.

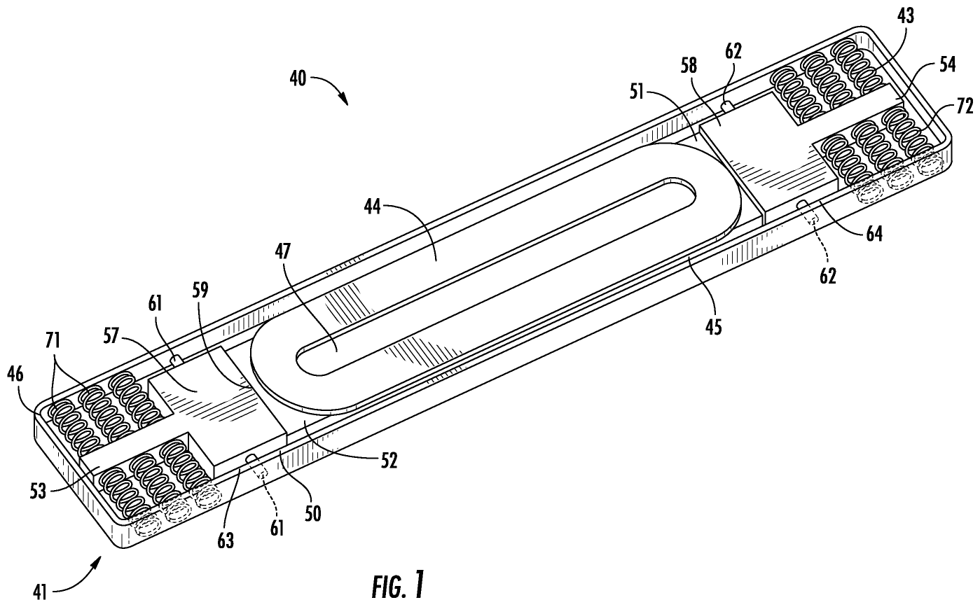

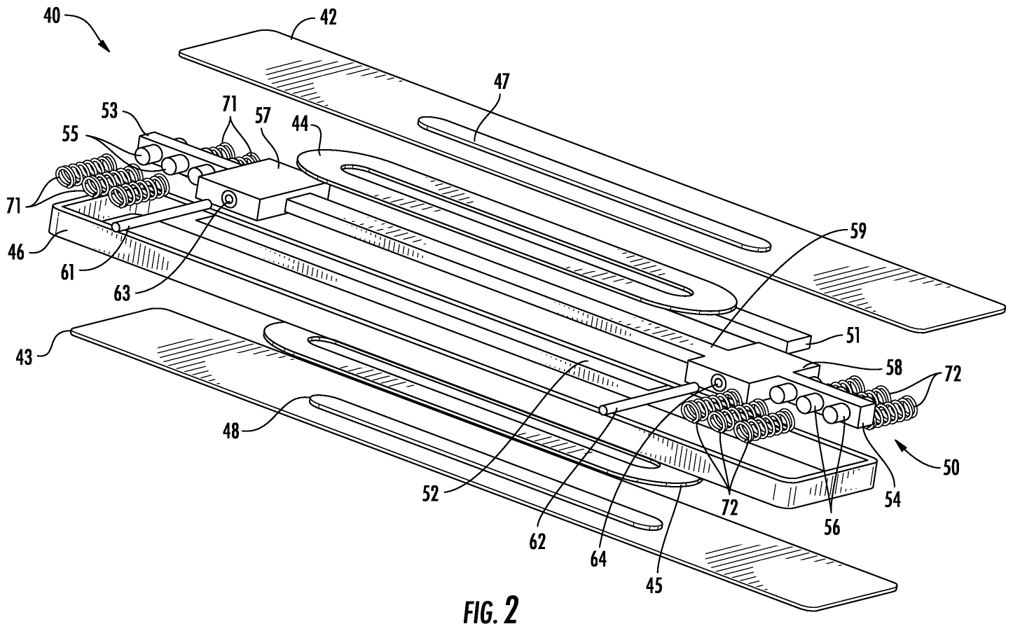

Referring to FIGS. 1 and 2, for example, one embodiment of a haptic actuator 40 includes a housing 41 having a top 42, a bottom 43, and a sidewall 46. The housing 41 has a rectangular shape. Of course, the housing 41 can be another shape and have different dimensions.

Respective mechanical stiffeners 47, 48 may be carried by the top 42 and bottom 43 of the housing 41. Each mechanical stiffener 47, 48 may be non-ferritic, and more particularly, non-ferritic steel. Any number of mechanical stiffeners may be used, including none, and may be carried by any portion of the housing 41.

The haptic actuator 40 also includes first and second coils 44, 45 (i.e., electrical coils) carried by the top and bottom 42, 43, respectively, of the housing 41. The first and second coils 44, 45 each illustratively have a loop shape or “racetrack” shape and are aligned in a stacked relation and spaced apart.

The haptic actuator 40 may also include a field member 50 carried by the housing. The field member 50 illustratively includes permanent magnets 51, 52 between the first and second coils 44, 45 and is movable within the housing 41. While the movement of the field member 50 may be described as being moveable in one direction, i.e., a linear haptic actuator, it should be understood that in some embodiments, the field member may be movable in other directions, i.e., an angular haptic actuator, or may be a combination of both a linear and an angular haptic actuator.

The permanent magnets 51, 52 may be neodymium, for example, and may be positioned with in opposing directions with respect to their respective poles. The permanent magnets 51, 52 also have a rectangular shape and are aligned along a length of the first and second coils 44, 45. While a pair of rectangular shaped permanent magnets is illustrated, it will be appreciated that there may be any number of permanent magnets having any shape between the first and second coils 44, 45.

The field member 50 also includes first and second ends 53, 54. The first and second ends 53, 54 have first and second sets of protrusions 55, 56 for coupling to first and second sets of biasing members 71, 72, respectively. The first and second sets of protrusions 55, 56 are illustratively in the form of circular protrusions and extend outwardly in opposing directions. An equal number of protrusions may extend in each direction.

The field member 50 includes a first mass 57 between the first end 53 and the permanent magnets 51, 52. A second mass 58 is between the second end 54 and the pair of permanent magnets 51, 52. A third mass 59 extends between the first and second masses 57, 58. The third mass 59 has a reduced width relative to the first and second masses 57, 58. This permits the permanent magnets 51, 52 to be on each side of the third mass 59. In some embodiments, a third mass 59 may not be included and/or the third mass may have a different shape, for example. Each of the first, second, and third masses 57, 58, 59 may be tungsten, for example. The first, second, and third masses base may each be a different material.

The first, second, and third masses 57, 58, 59 which collectively may be referred to as the “moving part,” are spaced from the first and second coils 44, 45 by a relatively small gap. In other words, the first and second coils 44, 45 do not touch the first, second, and third masses 57, 58, 59.

The haptic actuator 40 also includes a first shaft 61 slidably coupling the first mass 57 to the housing 41. A second shaft 62 slidably couples the second mass 58 to the housing 41. The first and second shafts 61, 62 may be a nickel-chromium alloy, for example. The first and second shafts 61, 62 may be generally parallel to each other, and as will be appreciated by those skilled in the art, may limit motion to a desired translational movement that may be parallel to y-axis (width). The first and second shafts 61, 62 may also limit movement in other directions, for example, lateral movement, rotation, and/or wobbling.

First and second mechanical bearings 63, 64 are carried by the first and second masses 57, 58 and slidably receive the first and second shafts. The first and second mechanical bearings 63, 64 may be slot bearings.

It will be appreciated by those skilled in the art that the first and second shafts 61, 62 may be sliding with respect to a combination of circular and slot bearings 63, 64 so that unwanted directions of force may be constrained while reducing the chances of jamming due to over-constraint. The first and second mechanical bearings may be mounted such that they are mounted on the moving mass 57, 58, 59 (and hence the shafts 61, 62 are fixed to the housing 41) or mounted on the housing (and hence the shafts are fixed to the moving mass).

The haptic actuator 50 also includes a first set of biasing members 71 between the first end 53 of the field member 50 and the housing 41 and a second set of biasing members 72 between the second end 54 of the field member and the housing. The first and second sets of biasing members 71, 72 may be springs, for example, and more particularly, coil and/or leaf springs, and may be steel. The first and second sets of biasing members 71, 72 may be other types of biasing members and may be another material. As noted above, the first, second, and third masses are spaced from the first and second coils 44, 45. The first and second sets of biasing members 71, 72 assist in maintaining this spacing, and increase stiffness. While twelve (12) total biasing members are shown in the form of coil springs (i.e., mechanical coils), it should be understood that any number and type of biasing members may be used. Each of the first and second sets of biasing members 71, 72 may each have an equal number thereof between a respective one of the first and second ends 44, 45 and adjacent portions of the housing, for example.

Notably, the polymer composition of the present invention may be employed in any of a variety of parts of the haptic actuator. Referring again to FIGS. 1 and 2, for instance, the polymer composition may be used to form all or a portion of the housing 41, including the top 42, the bottom 43, and the sidewall 46. Regardless, the desired part(s) may be formed using a variety of different techniques. Suitable techniques may include, for instance, injection molding, low-pressure injection molding, extrusion compression molding, gas injection molding, foam injection molding, low-pressure gas injection molding, low-pressure foam injection molding, gas extrusion compression molding, foam extrusion compression molding, extrusion molding, foam extrusion molding, compression molding, foam compression molding, gas compression molding, etc. For example, an injection molding system may be employed that includes a mold within which the polymer composition may be injected. The time inside the injector may be controlled and optimized so that polymer matrix is not pre-solidified. When the cycle time is reached and the barrel is full for discharge, a piston may be used to inject the composition to the mold cavity. Compression molding systems may also be employed. As with injection molding, the shaping of the polymer composition into the desired article also occurs within a mold. The composition may be placed into the compression mold using any known technique, such as by being picked up by an automated robot arm. The temperature of the mold may be maintained at or above the solidification temperature of the polymer matrix for a desired time period to allow for solidification. The molded product may then be solidified by bringing it to a temperature below that of the melting temperature. The resulting product may be de-molded. The cycle time for each molding process may be adjusted to suit the polymer matrix, to achieve sufficient bonding, and to enhance overall process productivity.

The resulting haptic actuator may be used in a wide variety of electronic devices as is known in the art, such as in portable electronic devices (e.g., mobile phones, portable computers, tablets, watches, etc.).

The present invention may be better understood with reference to the following examples.

### Test Methods

Melt Viscosity: The melt viscosity (Pa-s) may be determined in accordance with ISO Test No. 11443:2021 at a shear rate of 1,000 s⁻¹ or 400 s⁻¹ and temperature 15° C. above the melting temperature using a Dynisco LCR7001 capillary rheometer. The rheometer orifice (die) had a diameter of 1 mm, length of 20 mm, L/D ratio of 20.1, and an entrance angle of 180°. The diameter of the barrel was 9.55 mm+0.005 mm and the length of the rod was 233.4 mm.

Melting Temperature: The melting temperature (“Tm”) may be determined by differential scanning calorimetry (“DSC”) as is known in the art. The melting temperature is the differential scanning calorimetry (DSC) peak melt temperature as determined by ISO Test No. 11357-2:2020. Under the DSC procedure, samples were heated and cooled at 20° C. per minute as stated in ISO Standard 10350 using DSC measurements conducted on a TA Q2000 Instrument.

Deflection Temperature Under Load (“DTUL”): The deflection under load temperature may be determined in accordance with ISO Test No. 75-2:2013 (technically equivalent to ASTM D648-18). More particularly, a test strip sample having a length of 80 mm, thickness of 10 mm, and width of 4 mm may be subjected to an edgewise three-point bending test in which the specified load (maximum outer fibers stress) was 1.8 Megapascals. The specimen may be lowered into a silicone oil bath where the temperature is raised at 2° C. per minute until it deflects 0.25 mm (0.32 mm for ISO Test No. 75-2:2013).

Tensile Modulus, Tensile Stress, and Tensile Elongation: Tensile properties may be tested according to ISO Test No. 527:2019 (technically equivalent to ASTM D638-14). Modulus and strength measurements may be made on the same test strip sample having a length of 80 mm, thickness of 10 mm, and width of 4 mm. The testing temperature may be 23° C., and the testing speeds may be 1 or 5 mm/min.

Flexural Modulus, Flexural Stress, and Flexural Elongation: Flexural properties may be tested according to ISO Test No. 178:2019 (technically equivalent to ASTM D790-10). This test may be performed on a 64 mm support span. Tests may be run on the center portions of uncut ISO 3167 multi-purpose bars. The testing temperature may be 23° C. and the testing speed may be 2 mm/min.

Charpy Impact Strength: Charpy properties may be tested according to ISO Test No. ISO 179-1:2010) (technically equivalent to ASTM D256-10, Method B). This test may be run using a Type 1 specimen size (length of 80 mm, width of 10 mm, and thickness of 4 mm). When testing the notched impact strength, the notch may be a Type A notch (0.25 mm base radius). Specimens may be cut from the center of a multi-purpose bar using a single tooth milling machine. The testing temperature may be 23° C.

### Examples 1-5

Samples 1-5 are formed from various percentages of LCP 1, LCP 2, LCP 3, LCP 4, glass fiber, carbon fiber, carbon black, and a lubricant, as shown in Table 1. LCP 1 is formed from about 60 mol. % HBA, 13 mol. % TA, 12 mol. % BP, 8 mol. % HQ, and 7 mol. % IA. LCP 2 is formed from about 62.5 mol. % HBA, 5 mol. % HNA, 16.4 mol. % TA, 11.2 mol. % BP, and 5 mol. % APAP. LCP 3 is formed from 73 mol. % HBA and 27 mol. % HNA. LCP 4 is formed from 79.3 mol. % HBA, 20 mol. % HNA, and 0.7 mol. % TA. Values are provided in percent by weight of the total composition.

TABLE 1

| Sample | 1 | 2 | 3 | 4 | 5 |
|---|---|---|---|---|---|
| LCP 1 | 53.7 | 51.7 | 49.7 | 39.7 | 0 |
| LCP 2 | 4 | 4 | 4 | 4 | 4 |
| LCP 3 | 4.2 | 5.6 | 7 | 14 | 20 |
| LCP 4 | 0 | 0 | 0 | 0 | 39.7 |
| Glass Fiber | 35 | 35 | 35 | 35 | 35 |
| Carbon Fiber | 1.8 | 2.4 | 3 | 6 | 0 |
| Carbon Black | 1 | 1 | 1 | 1 | 1 |
| Lubricant | 0.3 | 0.3 | 0.3 | 0.3 | 0.3 |

Parts are injection molded from the samples of Examples 1-5 into plaques and tested for mechanical properties. The results are set forth below in Table 2.

TABLE 2

| Sample | 1 | 2 | 3 | 4 | 5 |
|---|---|---|---|---|---|
| Melt Viscosity (Pa-s) at 400 s⁻¹) | 59 | 50 | 54 | 72 | 72 |
| Melt Viscosity (Pa-s) at 1000 s⁻¹) | 40 | 35 | 36 | 45 | 45 |
| DTUL at 1.8 MPa (° C.) | 250 | 247 | 246 | 236 | 236 |
| Charpy Unnotched (kJ/m²) | 26 | 28 | 27 | 23 | 23 |
| Charpy Notched (kJ/m²) | 17 | 18 | 17 | 16 | 16 |
| Tensile Strength (MPa) | 143 | 152 | 148 | 148 | 148 |
| Tensile Modulus (MPa) | 20,740 | 21,953 | 22,735 | 24,442 | 24,442 |
| Tensile Elongation (%) | 0.98 | 0.98 | 0.9 | 0.9 | 0.89 |
| Flexural Strength (MPa) | 216 | 220 | 220 | 228 | 228 |
| Flexural Modulus (MPa) | 19,994 | 20,692 | 21,555 | 22,712 | 22,712 |
| Flexural Elongation (%) | 1.56 | 1.53 | 1.43 | 1.34 | 1.34 |

### Examples 6-10

Samples 6-10 are formed from various percentages of LCP 3, LCP 4, carbon fiber, and a lubricant, as shown in Table 3.

TABLE 3

| Sample | 6 | 7 | 8 | 9 | 10 |
|---|---|---|---|---|---|
| LCP 3 | 60 | 0 | 0 | 0 | 0 |
| LCP4 | 0 | 59.7 | 69.7 | 69.7 | 74.7 |
| Carbon Fiber | 40 | 40 | 30 | 30 | 25 |
| Lubricant | 0 | 0.3 | 0.3 | 0.3 | 0.3 |

Parts are injection molded from the samples of Examples 6-10 into plaques and tested for mechanical properties. The results are set forth below in Table 4.

TABLE 4

| Sample | 6 | 7 | 8 | 9 | 10 |
|---|---|---|---|---|---|
| Melt Viscosity (Pa-s) at 400 s⁻¹) | 250 | 52 | 51.3 | 51 | 30.5 |
| Melt Viscosity (Pa-s) at 1000 s⁻¹) | 157 | 42 | 31.4 | 30.7 | 18.7 |
| DTUL at 1.8 MPa (° C.) | 233 | 253 | 255 | 253 | |
| Charpy Unnotched (kJ/m²) | 15 | 18 | 33 | 33 | 42 |
| Charpy Notched (kJ/m²) | 7 | 12 | 12 | 12 | 17 |
| Tensile Strength (MPa) | 185 | 148 | 182 | 181.06 | 189 |
| Tensile Modulus (MPa) | 35,297 | 32,344 | 32,583 | 32,300 | 30,260 |
| Tensile Elongation (%) | 0.71 | 0.58 | 0.82 | 0.81 | 0.97 |
| Flexural Strength (MPa) | 295 | 236 | 272 | 269 | 270 |
| Flexural Modulus (MPa) | 34,773 | 32,141 | 29,813 | 29,883 | 27,142 |
| Flexural Elongation (%) | 1.21 | 0.99 | 1.36 | 1.32 | 1.55 |

These and other modifications and variations of the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed is:

1. A haptic actuator comprising:
a housing having a top and a bottom and at least one sidewall between the top and bottom;
first and second permanent magnets carried by the top and bottom, respectively, of the housing;
a field member carried by the housing and comprising at least one coil between the first and second permanent magnets, first and second ends; and
optionally, one or more mechanical stiffeners carried by the top of the housing, the bottom of the housing, or both;
wherein the haptic actuator comprises a polymer composition that has a melting temperature of about 250° C. or more and a tensile modulus of about 16,000 MPa or more as determined in accordance with ISO 527:2019 at a temperature of 23° C.

2. The haptic actuator of claim 1, wherein the polymer composition exhibits a melt viscosity of 200 Pa-s or less as determined at a shear rate of 400 seconds⁻¹ and at a temperature 15° C. higher than the melting temperature of the composition in accordance with ISO 11443:2021.

3. The haptic actuator of claim 1, wherein the polymer composition exhibits a flexural modulus of about 15,000 MPa or more as determined in accordance with ISO 178:2019 at 23° C.

4. The haptic actuator of claim 1, wherein the polymer composition exhibits a Charpy unnotched impact strength of about 10 kJ/m² or more as determined at 23° C. according to ISO 179-1:2010.

5. The haptic actuator of claim 1, wherein the polymer composition exhibits a Charpy notched impact strength of about 5 kJ/m² or more as determined at 23° C. according to ISO 179-1:2010.

6. The haptic actuator of claim 1, wherein the polymer composition exhibits a tensile strength of from about 120 to about 500 MPa as determined in accordance with ISO 527:2019.

7. The haptic actuator of claim 1, wherein the polymer composition exhibits a deflection temperature under load of about 180° C. or more as measured according to ISO 75-2:2013 at a specified load of 1.8 MPa.

8. The haptic actuator of claim 1, wherein the polymer composition exhibits a flexural modulus of about 15,000 MPa or more as determined in accordance with ISO Test No. 178:2019 at 23° C.

9. The haptic actuator of claim 1, wherein the polymer composition exhibits a flexural strength of from about 100 MPa to about 500 MPa as determined in accordance with ISO Test No. 178:2019 at 23° C.

10. The haptic actuator of claim 1, wherein the polymer composition comprises a polymer matrix with reinforcing fibers dispersed therein.

11. The haptic actuator of claim 10, wherein the polymer matrix contains a first liquid crystalline polymer comprising repeating units derived from 4-hydroxybenzoic acid.

12. The haptic actuator of claim 11, wherein the first liquid crystalline polymer further contains repeating units derived from terephthalic acid, isophthalic acid, hydroquinone, and 4,4′-biphenol.

13. The haptic actuator of claim 12, wherein the molar amount of 4,4′-biphenol is greater than the molar amount of hydroquinone and/or the molar amount of terephthalic acid is greater than the molar amount of isophthalic acid.

14. The haptic actuator of claim 13, wherein the polymer matrix further comprises a second liquid crystalline polymer.

15. The haptic actuator of claim 14, wherein the second liquid crystalline polymer comprises units derived from 6-hydroxy-2-naphthoic acid.

16. The haptic actuator of claim 15, wherein the second liquid crystalline polymer contains units derived from 6-hydroxy-2-naphthoic acid in an amount from about 10 mol. % to about 40 mol. %.

17. The haptic actuator of claim 16, wherein the first liquid crystalline polymer constitutes from about 50 wt. % to about 95 wt. % of the polymer matrix and the second liquid crystalline polymer constitutes from about 5 wt. % to about 50 wt. % of the polymer matrix.

18. The haptic actuator of claim 10, wherein the polymer matrix contains at least one high naphthenic liquid crystalline polymer comprising repeating units derived from 6-hydroxy-2-naphthoic acid in an amount from about 10 mol. % to about 40 mol. %.

19. The haptic actuator of claim 18, wherein high naphthenic liquid crystalline polymers constitute about 50 wt. % or more of the total amount of liquid crystalline polymers in the composition.

20. The haptic actuator of claim 10, wherein the reinforcing fibers comprise glass fibers.

21. The haptic actuator of claim 10, wherein the reinforcing fibers comprise carbon fibers.

22. The haptic actuator of claim 10, wherein the reinforcing fibers comprise carbon fibers and glass fibers.

23. The haptic actuator of claim 22, wherein the ratio of glass fibers to carbon fibers by weight is from about 1:10 to about 25:1.

24. The haptic actuator of claim 10, wherein the reinforcing fibers constitute from about 10 wt. % to about 70 wt. % of the composition.

25. The haptic actuator of claim 1, wherein at least a portion of the housing contains the polymer composition.

26. An electronic device comprising the haptic actuator of claim 1.

27. The electronic device of claim 26, wherein the device is a mobile phone, portable computer, tablet, or watch.
